(19) United States
(12) Patent Application Publication
(10) Pub. No.: US 2003/0059751 A1
(43) Pub. Date: Mar. 27, 2003

(54) Emergency/medical documentation and communication system and method

(76) Inventor: Nancy Dickerson Welles, Oriental, NC (US)

Correspondence Address: Nancy Dickerson Welles, P.O. Box 218, Oriental, NC, 28571, US

(21) Appl. No.: 10/288,073

(22) Filed: Nov. 4, 2002

Related U.S. Application Data
(63) Continuation-in-part of application No. 09/698,940, filed on Oct. 30, 2000, now Pat. No. 6,464,506.

(51) Int. Cl. G09B 19/00

(52) U.S. Cl. 434/238

(57) ABSTRACT

The present invention relates to a system and method for documenting and communicating emergency and medical information specific to an individual, between the individual, care givers, and health care providers in an accurate, concise, and easy-to-use format to help insure more timely, safe, and effective health care and to avoid unnecessary delays and unsafe and incomplete medical care due to a lack of communication and information. Additionally, the information is documented at a single site, requires no specialized machinery to imprint or to read, is portable, inexpensive, and updated continuously by the individual user, care givers, and health care providers. The documentation and communication tool is to be taken by the individual to all physician visits, emergency room visits, hospital admissions, pharmacy visits, and is to be attached to the refrigerator inside the individual's home when not in use for easy access in emergency situations.

### CROSS-REFERENCE TO RELATED APPLICATIONS

This is a continuation-in-part of patent application Ser. No. 09/698,940 filed Oct. 30, 2000, now U.S. Pat. No. 6,464,506 B1 granted Oct. 15, 2002.

### GOVERNMENT RIGHTS

This invention is part of a larger invention that was made with government support under Grant No. IR43 NR05021-01 awarded by the National Institutes of Health. The Government has certain rights in the invention.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The present invention relates to a system and method for documenting and communicating emergency and medical information specific to an individual, between individuals, care givers, and health care providers in an accurate, concise, and easy-to-use format to help ensure more timely, safe, and effective health care and to avoid unnecessary delays and unsafe and incomplete medical care due to a lack of communication and information.

Foremost in safe and efficient health care is accurate documentation and clear communication between individuals, care givers, and health care providers. Lack of communication and lack of access to pertinent medical information often makes adequately caring for the individual challenging, difficult, and at times, impossible, for health care providers. Furthermore, necessary and complete health care records are often time consuming to find, especially in emergency situations when prompt and effective care directly impacts outcome; often making the difference between recovery or disability, life or death. Relying on the individual or their care givers for reliable information is often inadequate. Individuals and their care givers are often poor historians and are either unfamiliar with or unable to communicate current health problems and prescribed treatments effectively. This is especially true during illness or in emergency situations. The elderly are especially at risk for the above noted problems as with increased age often comes increased medical problems further complicated by increased senescence and senility. Keeping all individuals healthy, safe, and independently functioning is not only beneficial to the individual for financial and quality of life issues, but also to society as a whole by decreasing the care and financial burden on care givers and health care systems alike.

Further complicating the health care of individuals is the fact that oftentimes individuals see multiple doctors who prescribe multiple medications and treatments. Frequently, physicians are unaware of the others involvement, therefore, causing potentially dangerous situations to occur. Individuals commonly use more than one pharmacy; again, adding to the confusion of what medications the individual is currently taking. In situations where referrals are made from one physician's office to another for specialized care, the transfer of records is often slow and incomplete. When the necessary information does arrive, it is often mountainous and disorganized requiring one to search through pages of records to find what is pertinent. As the population grows and more medical advances are made, the above noted problems are likely to worsen. The elderly population is especially at risk as life expectancies continue to rise. In the United States alone, there were 35 million aged 65 and older in the year 2000. Current population projections estimate by the year 2050 there will be over 80 million age 65 and older.

A communication system and method that documents and communicates pertinent and accurate medical/emergency information at a single site, is easy to use, requires no specialized machinery to imprint or to read, is portable, inexpensive, and updated continuously, and is designed to remain in a highly visible designated location when not in use would greatly alleviate the above noted problems. Reducing the above noted problems would greatly enhance the health care system by readily providing accurate and succinct information thus, streamlining communication and enhancing safe care. Miscommunication between individuals, care givers, and health care providers would be greatly reduced as necessary information would be readily available to all health care providers and available to photocopy as an adjunct to existing records. Money and time spent on unnecessary medical visits and hospitalizations resulting from incomplete or miscommunication would also be reduced representing a significant savings to the over burdened health care industry.

In seeking to enhance communication in the health care industry, various aids have been proposed including identification cards, medical information cards, information packages, and information containing jewelry. While helpful to a degree, they do not provide a comprehensive, easy to use approach to interactive communication and, in general, address only specific health issues or areas of information. Identification cards that are carried in ones wallet provide limited information or require specialized equipment to use. In U.S. Pat. No. 4,680,459 by Dexler, the micrographic pocket data card, while providing important health information, requires specialized equipment to imprint and read. U.S. Pat. No. 5,171,039 by Dusek, provides a medical card that requires data entry at a specialized center that is transmitted to a data base where it is reproduced on software then laser printed. Furthermore, this card is then laminated making changes to the card a lengthy process. U.S. Pat. No. 4,435,912 by Adrian, et al entails a card providing medical and emergency information partially readable and partially contained on microfilm. The necessary lens to read the microfilm is attached, however, this card is sealed and therefore, not easily updated, is not interactive, and may not be photocopied. None of the above cards provide a means for communicating other pertinent health care information not contained on the card. U.S. Pat. No. 3,958,690 by Gee involves a medical information and identification card accompanied by an emergency dose of medication to be administered in an emergency situation. This product provides limited general medical information and predominately addresses specific medical conditions requiring prompt medication such as diabetes. U.S. Pat. No. 5,984,685 by Portnoy is a medical action system involving cards specific to certain diseases with corresponding disease symptoms and actions to take but does not include overall health information. The personal information package by Stephens, U.S. Pat. No. 5,380,046 provides personal information to be carried by the individual to provide identification and relevant information to authorities in the event of an emergency. This package is laminated closed and to be entered only in an emergency situation. This product is not interactive and only used as a communication tool in an emergency. U.S. Pat. No. 4,621,729 by Jackson, involves a patient education and information container. While the container is easily carried and contains medical information, it predominately focuses on prescribed and potential medications related to one's health conditions including possible allergies and drug interactions. The product is not interactive, not designed for continuous updating, and is not intended to remain in a highly visible designated location while not in use as to be easily accessible in emergency situations. U.S. Pat. No. 6,223,559 by Coleman involves a medical identification charm bracelet with audible and visual output to draw attention to the information inscribed on the charms. While providing information, such a device is not easily updated, not interactive, unable to be photocopied, and unable to provide any additional information not inscribed on the individual charms.

### BRIEF SUMMARY OF THE INVENTION

An interactive, portable, emergency/medical documentation and communication system and method for documenting and communicating up-to-date, pertinent, emergency and medical information relative to the individual user. The system and method consists of a foldable form that contains printed emergency/medical information and is housed along with other pertinent health care forms in a document holder. The form is continuously updated by the individual, the individual's care givers, and health care providers and is taken by the individual to all medical appointments, pharmacy visits, emergency room visits, and hospitalizations to serve as an accurate and concise communication tool for the individual and all health care providers. The form is to be promptly updated as changes occur with the individual's health and plan of care and can be photocopied and retained by health care providers as an adjunct to other medical records. Attached to this card are other relevant medical and emergency directives such as a Living Will, Health Care Power of Attorney, Organ Donation information, and DNR (do not resuscitate). All documents are housed in a portable, magnetized holder that is to be stored attached to the refrigerator inside the individual's home when not in use for easy access by emergency personnel if summoned to the individual's home.

Advantages to this product over existing products include offering a system and method for organizing and housing one's pertinent emergency and medical information at a single, portable site in a complete, concise, easily updated, and easily read format. The locating of pertinent and accurate information that oftentimes burdens the health care provider and impedes timely and prudent health care delivery would be alleviated. Miscommunication, erroneous information, and incomplete information posing delays in prompt and quality health care and contributing to potentially serious safety risks to individuals and health care providers alike would be greatly reduced, thus providing an avenue for a better and safer health care system. With this product, individuals and their care givers are free of the responsibility of remembering all necessary health problems and histories, physician's names and numbers, current treatments, etc. as all necessary information is readily available and contained in the portable holder.

Accordingly, it is an object of the invention to offer a system and method for organizing and providing each individual's complete, pertinent, up-to-date medical and emergency information at a single portable site. This would enable every health care provider timely access to complete medical records for an individual thus streamlining communication in the health care industry and enhancing safe care.

Another object of the invention is to increase patient safety in the health care setting by providing timely, accurate, and up-to-date medical information on all individuals to health care providers.

A further object of the invention is to promote healthy, safe, and independent functioning, especially for the elderly and medically challenged populations by providing them with the necessary tool to communicate all pertinent medical and emergency information without relying on verbal recall by themselves or others.

Yet another object of the invention is to save individuals and health care systems alike time and money by reducing unnecessary medical visits and hospitalizations caused by incomplete or miscommunications.

Yet another object of the invention is to offer a documentation system that can be easily updated and photocopied by medical personnel to serve as adjunct medical records to their patient's existing records.

Another object of the invention is to provide a documentation and communication tool that is comprehensive and interactive so that all parties involved in the care of an individual can intercommunicate.

### BRIEF DESCRIPTION OF THE SEVERAL VIEWS OF THE DRAWING

The above and other features and advantages of the present invention will become apparent upon reading the following detailed description taken in conjunction with the accompanying drawings in which:

FIG. 1 is a front perspective view of the document holder containing the “Emergency/Medical” form in accordance with the embodiment of the invention;

FIG. 2 is a rear perspective view of the holder illustrated in FIG. 1;

FIG. 3 is a perspective front view of the document holder illustrated in FIG. 1 illustrating removal of the emergency/medical document;

FIG. 4 is the front view of the emergency/medical form for the holder; and

FIG. 5 is the rear view of the emergency/medical form for the holder.

### DETAILED DESCRIPTION OF THE INVENTION

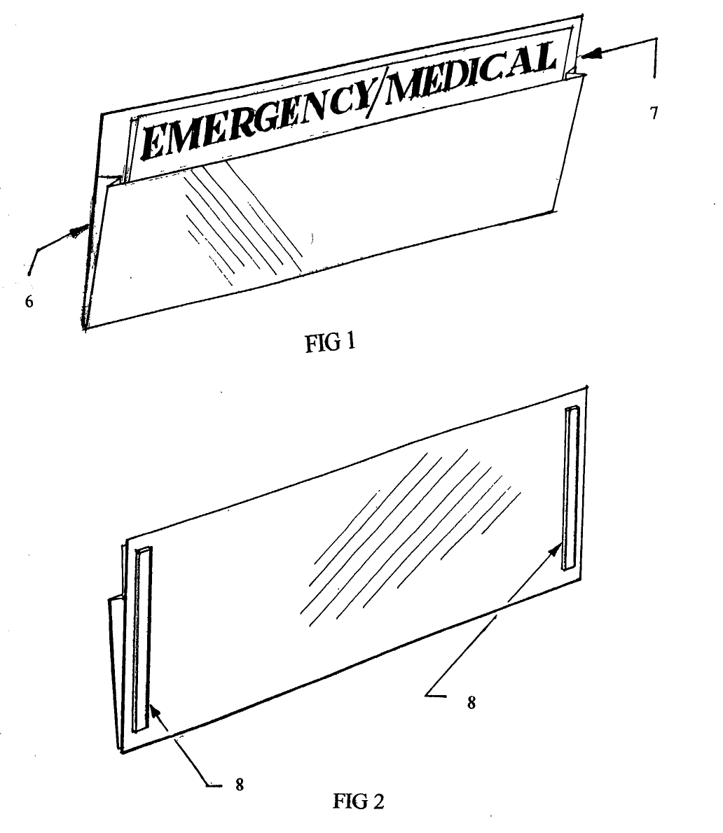

Referring to the drawings for the purpose of describing the preferred embodiments of the present invention and not for limiting same, FIG. 1, there is shown a front perspective view of the portable document holder holding the folded “Medical/Emergency” form 7 containing concise, accurate, and up-to-date medical and emergency information pertinent to the specific individual user. The holder is made of a heavy, durable material such as card stock, plastic, or vinyl that is closed on three sides. The holder is open only at the top for the easy removal and placement of the folded forms housed in the holder. The holder is generally rectangular in shape and is accordion constructed 6 to expand sufficiently to hold a varying number of documents so that other health care directives such a living will, health care power of attorney, do not resuscitate orders, etc. can also be placed in the holder along with the “Emergency/Medical” form. The form entitled “Emergency/Medical” 7 is shown folded in the holder. Only the title of the form is visible and all other information contained on the form is obscured from view unless the form is withdrawn from the holder. The form is made of a heavy paper generally 8.5×14 inches with the headings for each category preprinted on the form. The form is folded upon itself accordingly to fit inside the holder as illustrated in FIG. 1.

FIG. 2 is a rear perspective view of the document holder in FIG. 1. Two magnetized strips 8 are located down each side of the rear of the holder. These strips are adhered in place by some type of adhesive material. The magnetized strips 8 are of sufficient strength and size to hold the document holder and forms contained within in place on a metal surface such as a refrigerator.

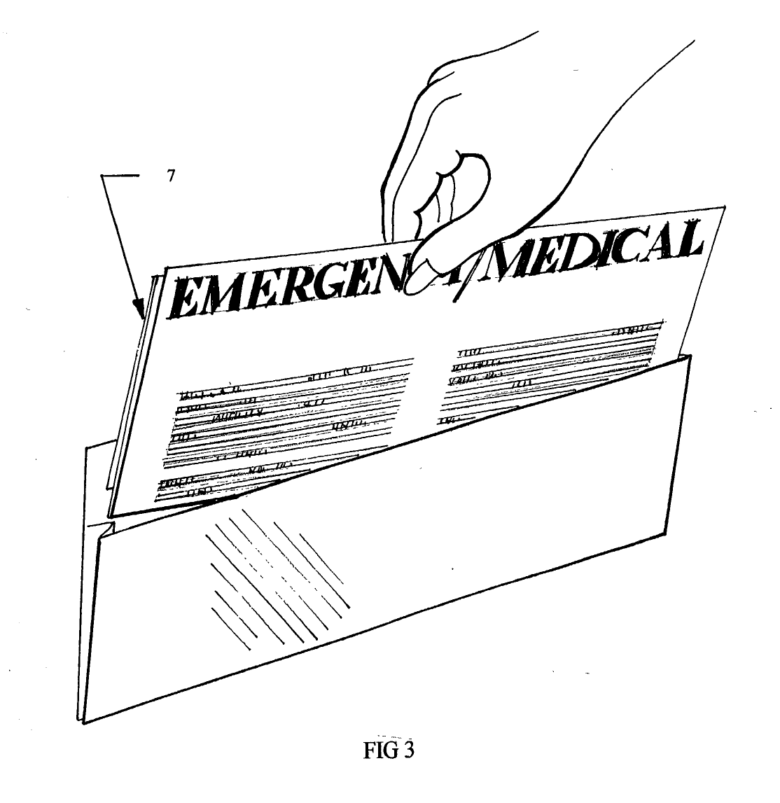

FIG. 3 is a perspective view of the document holder in FIG. 1. FIG. 3 illustrates the folded “Emergency/Medical” form 7 being easily removed from the holder.

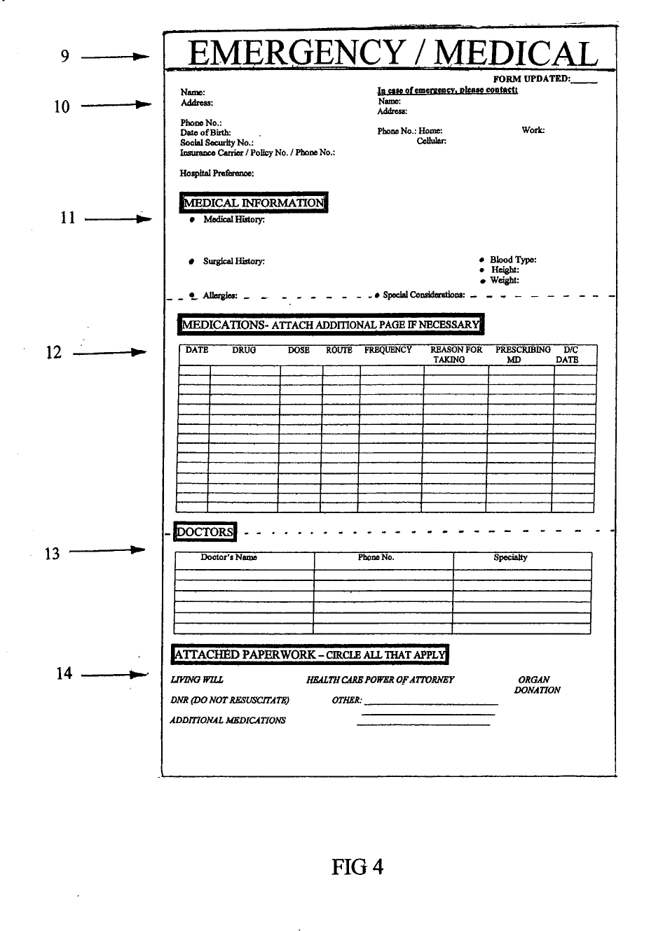

FIG. 4 is the front view of the “Emergency/Medical” form. The front panel includes a header section 9 entitled “Emergency/Medical”. Below the header section is a legend area 10 for entry of identifying information regarding the patient and emergency notification information. Below the legend area is a Medical Information legend 11 for entry of specific medical and surgical information relative to the patient. Provided below the medical information legend is a Medications table 12 for entering and updating medications prescribed for the patient and information relevant thereto. Below the Medications table is a Doctors legend 13 for listing information regarding treating physicians for the patient. Below the Doctors legend is an Attached Paperwork legend 14 for listing other important documents contained in the holder. Preprinted dash lines are located on the form to assure the prescribed folding of the forms.

The information on the front panel of the form is a particularly beneficial compilation for use by the patient, associated care givers, and health care providers as a documentation and communication tool. While the headings to each category are preprinted on the form, the information specific to the individual user is generally hand printed on the form. Information that generally does not change such as demographic information and medical information can be printed in ink. Information that oftentimes changes such as medications may be printed in pencil thus allowing information to be easily changed and updated. All or some of the same information may also be computer printed on the form. The form provides complete and accurate medical and emergency information designed to streamline communication and enhance safe care. The form may be taken to pharmacy visits, medical appointments, emergency room visits, hospital admissions, or used by emergency personnel in answering 911 calls. Patient safety is greatly enhanced as it communicates medical and emergency information in a succinct, accurate, and concise format thereby avoiding the need for patient recall of health history, treating physicians or current treatments.

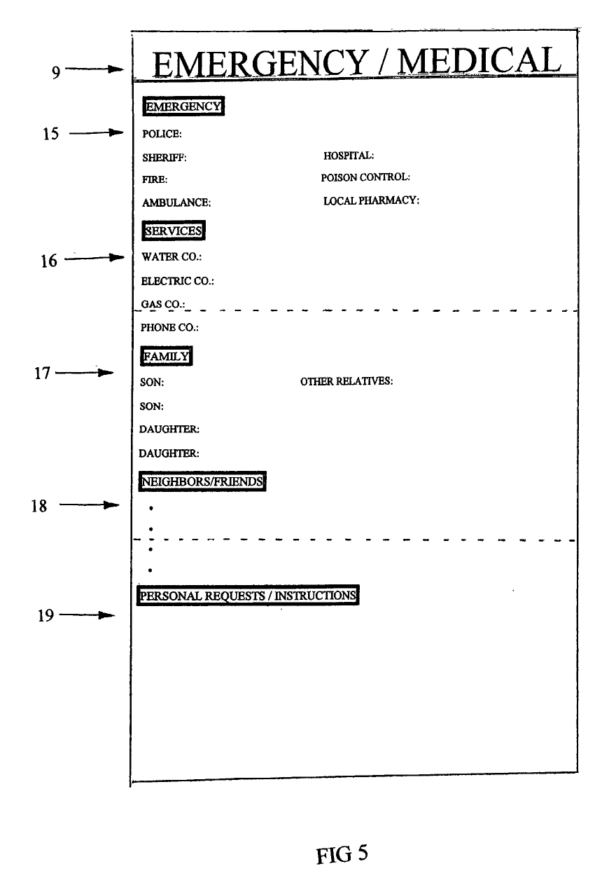

FIG. 5 is a rear view of the “Emergency/Medical” form. The rear panel includes the same header section 9 entitled “Emergency/Medical”. Below the title is an Emergency legend 15 for common emergency services and numbers. Below the Emergency legend is a Services legend 16 for utility services and numbers relevant to the user. Beneath the Services legend is a Family legend 17 containing names and numbers of various family members of the individual user. Below the Family legend is a Neighbors/Friends legend 18 containing the names and numbers of neighbor and friends of the individual. Below the Neighbors/Friends section is a Personal Requests/Instructions legend 19 for any additional information or instructions that the individual user would want to communicate. Preprinted dash lines are located on the form to assure the prescribed folding of the form. All information contained on the rear panel is designed for easy access of information for reference by the individual or third parties for general use and in case of emergency. Common numbers of emergency services, utility information, family contacts, neighbors and personal requests by the individual provide invaluable information for handling emergency situations involving the individual.

Having thus described a presently preferred embodiment of the present invention, it will now be appreciated that the objects of the invention have been fully achieved, and it will be understood by those skilled in the art that changes in construction and differing embodiments and applications of the invention will suggest themselves without departing from the spirit and scope of the present invention. The disclosures and description herein are intended to be illustrative and are not in any sense limiting of the invention, which is defined solely in accordance with the following claims.

I claim:

1. A portable, interactive, emergency/medical documentation and communication system and method consisting of:
a. a generally rectangular shaped accordion constructed document holder, open only at the top and of sufficient size and construction to hold a varying number of folded documents;
b. a foldable form containing pertinent emergency and medical information that when folded width wise and placed in the document holder in “a” above, is superimposed on itself in such a manner that only the top portion of the form revealing the title of the card can be clearly viewed from the face of the said holder and all other information is obscured from view while in the holder.

2. The foldable form as defined in claim 1 contains locations for pertinent, printed, medical and emergency information relative to the individual user including but not limited to: demographic and identification information, emergency contact information, insurance information, hospital preference data, medical history, surgical history, allergies, height, weight, blood type, special considerations, medications, treating physicians' names and phone numbers, living will designation, organ donation designation, health care power of attorney information, do not resuscitate information, and “other” attached information.

3. The foldable form as defined in claim 1 contains locations for entering other printed emergency/medical information pertinent to the individual user including but not limited to: police, sheriff, fire, ambulance, hospital, poison control, pharmacy, utility service names/numbers (water, electric, gas, phone), family member names/numbers, neighbors' and friends' names/numbers, and personal requests/instructions.

4. The document holder in claim 1 is magnetized to adhere to a metal surface such as a refrigerator.

5. The document holder in claim 1 is of sufficient size and configuration to hold other documents such as living will, health care power of attorney, do not resuscitate, lab results, xray and other diagnostic results.

6. The foldable form as defined in claim 1 contains preprinted dash lines to assist in the prescribed folding of the form and all attached documents.
